(19) United States
(12) Patent Application Publication
(10) Pub. No.: US 2025/0294568 A1
(43) Pub. Date: Sep. 18, 2025

(54) METHOD AND APPARATUS FOR TRANSMITTING AND RECEIVING DOWNLINK CHANNEL AND SIGNAL INTEGRATED WITH SENSING

(71) Applicant: Electronics and Telecommunications Research Institute, Daejeon (KR)

(72) Inventors: Woncheol CHO, Daejeon (KR); Kapseok CHANG, Daejeon (KR); Young Jo KO, Daejeon (KR); Yong Sun KIM, Daejeon (KR)

(21) Appl. No.: 19/079,276

(22) Filed: Mar. 13, 2025

(30) Foreign Application Priority Data
Mar. 13, 2024 (KR) 10-2024-0035422
May 3, 2024 (KR) 10-2024-0059434
Mar. 10, 2025 (KR) 10-2025-0030845

(51) Int. Cl. H04W 72/23; H04L 27/10

(52) U.S. Cl. CPC H04W 72/23; H04L 27/103

(57) ABSTRACT

A method of a base station may comprise: generating control information for a sensing-integrated downlink channel and signal based on terminal capability information received from a terminal; generating the sensing-integrated downlink channel and signal based on the control information and transmitting the sensing-integrated downlink channel and signal to the terminal; receiving a reflected sensing-integrated downlink channel and signal for the sensing-integrated downlink channel and signal from the terminal; and determining a round-trip delay for the sensing-integrated downlink channel and signal based on the reflected sensing-integrated downlink channel and signal.

### CROSS-REFERENCE TO RELATED APPLICATIONS

This application claims priority to Korean Patent Applications No. 10-2024-0035422, filed on Mar. 13, 2023, No. 10-2024-0059434, filed on May 3, 2024, and No. 10-2025-0030845, filed on Mar. 10, 2025, with the Korean Intellectual Property Office (KIPO), the entire contents of which are hereby incorporated by reference.

### BACKGROUND

### 1. Technical Field

The present disclosure relates to a signal transmission technique in a communication network, and more particularly, to a method and an apparatus for transmitting and receiving a downlink channel and signal integrated with sensing.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

A round-trip time (RTT) scheme is used in a communication system to estimate a round-trip delay between a base station and a terminal. In the RTT scheme, the terminal may receive a downlink reference signal or synchronization signal from the base station and estimate a downlink reception timing. Similarly, the base station may receive an uplink reference signal from the terminal, estimate an uplink reception timing, and determine the round-trip delay.

In the RTT scheme of a communication system, transmission and reception timing errors between the base station and the terminal may occur, leading to errors in round-trip delay estimation. The accuracy of round-trip delay estimation varies depending on the terminal's performance, which may result in estimation errors.

The round-trip delay estimation error may be inversely proportional to a frequency bandwidth allocated to the reference signal or synchronization signal. To improve the accuracy of round-trip delay estimation, a wider frequency bandwidth for signals exchanged between the base station and the terminal, such as downlink or uplink signals, may be required.

Consequently, the communication system may face constraints in analog beamforming at high-frequency bands or limitations in multi-user scheduling. Additionally, since the terminal needs to transmit and receive signals with the base station over a wide frequency bandwidth for round-trip delay estimation, power consumption may increase. Therefore, there is a need for a method to enhance the accuracy of round-trip delay estimation.

### SUMMARY

The present disclosure for resolving the above-described problems is directed to providing a method and an apparatus for transmitting and receiving a downlink channel and signal integrated with sensing to improve accuracy the accuracy of round-trip delay estimation with limited bandwidth.

A method of a base station for transmitting and receiving a downlink channel and signal integrated with sensing, according to an exemplary embodiment of the present disclosure, may comprise: generating control information for a sensing-integrated downlink channel and signal; generating the sensing-integrated downlink channel and signal based on the control information and transmitting the sensing-integrated downlink channel and signal to a terminal; receiving a reflected sensing-integrated downlink channel and signal for the sensing-integrated downlink channel and signal from the terminal; and determining a round-trip delay for the sensing-integrated downlink channel and signal based on the reflected sensing-integrated downlink channel and signal.

Wherein the method of the base station further comprises: receiving terminal capability information from the terminal, and the generating of the control information may comprise: generating a chirp filtering sequence from a combination of a plurality of parameters based on the terminal capability information; and generating the combination of the plurality of parameters and the chirp filtering sequence as the control information.

The generating of the chirp filtering sequence may comprise: generating one chirp filtering sequence of a linear up-down chirp filtering sequence, a linear down-up chirp filtering sequence, an exponential chirp filtering sequence, and a hyperbolic chirp filtering sequence based on the combination of the plurality of parameters.

The generating of the chirp filtering sequence may comprise: generating a frequency shift value for frequency shift keying (FSK) modulation of the terminal based on the terminal capability information; generating a new parameter combination by resetting a value of each of the plurality of parameters based on the frequency shift value; and generating the chirp filtering sequence based on the new parameter combination.

The control information may include a time-domain chirp filtering sequence generated based on a combination of a plurality of parameters, and the generating of the sensing-integrated downlink channel and signal and transmitting of the sensing-integrated downlink channel and signal to the terminal may comprise: transforming the time-domain chirp filtering sequence into a frequency-domain chirp filtering sequence; obtaining transmission modulation symbols based on the frequency-domain chirp filtering sequence; and converting the transmission modulation symbols into an RF signal and transmitting the RF signal as the sensing-integrated downlink channel and signal.

The determining of the round-trip delay may comprise: transforming the reflected sensing-integrated downlink channel and signal to obtain a frequency-domain signal; de-mapping an effective bandwidth of the frequency-domain signal to obtain received modulation symbols; equalizing the received modulation symbols to obtain equalized received modulation symbols; obtaining a beat signal from the equalized received modulation symbols; and determining the round-trip delay by obtaining at least one of an estimated beat frequency, an estimated distance, or an estimated resolution from the beat signal.

The obtaining of the beat signal may comprise: transforming the equalized received modulation symbols to obtain time-domain equalized received modulation symbols; obtaining a time-domain beat signal from the time-domain equalized received modulation symbols; and transforming the time-domain beat signal to obtain a frequency-domain beat signal.

The determining of the round-trip delay may comprise: obtaining a frequency-domain beat signal from the reflected sensing-integrated downlink channel and signal; obtaining a time-domain beat signal by transforming the frequency-domain beat signal; obtaining a down-sampled beat signal from the time-domain beat signal based on a preset decimation factor; obtaining a padded beat signal from the down-sampled beat signal; and determining the round-trip delay from the padded beat signal based on the decimation factor.

The obtaining of the time-domain beat signal may comprise: phase-rotating the frequency-domain beat signal and transforming the phase-rotated frequency-domain beat signal to obtain the time-domain beat signal.

The obtaining of the padded beat signal may comprise: combining down-sampled beat signals with different decimation points in a co-phasing manner; zero-padding the combined down-sampled beat signals to obtain a time-domain padded beat signal; and transforming the time-domain padded beat signal to obtain a frequency-domain padded beat signal.

A method of a terminal for transmitting and receiving a downlink channel and signal integrated with sensing, according to an exemplary embodiment of the present disclosure, may comprise: receiving a sensing-integrated downlink channel and signal from a base station; reflecting the sensing-integrated downlink channel and signal to the base station; estimating an effective channel from the sensing-integrated downlink channel and signal; and decoding the sensing-integrated downlink channel and signal based on the estimated effective channel.

The estimating of the effective channel may comprise: obtaining a frequency-domain signal by transforming the sensing-integrated downlink channel and signal; de-mapping the frequency-domain signal to obtain received modulation symbols; equalizing the received modulation symbols to obtain equalized received modulation symbols; and estimating the effective channel from the equalized received modulation symbols.

A base station for transmitting and receiving a downlink channel and signal integrated with sensing, according to an exemplary embodiment of the present disclosure, may comprise at least one processor, and the at least one processor may cause the base station to perform: generating control information for a sensing-integrated downlink channel and signal; generating the sensing-integrated downlink channel and signal based on the control information and transmitting the sensing-integrated downlink channel and signal to a terminal; receiving a reflected sensing-integrated downlink channel and signal for the sensing-integrated downlink channel and signal from the terminal; and determining a round-trip delay for the sensing-integrated downlink channel and signal based on the reflected sensing-integrated downlink channel and signal.

The at least one processor may cause the base station to perform: receiving terminal capability information from the terminal, generating one chirp filtering sequence of a linear up-down chirp filtering sequence, a linear down-up chirp filtering sequence, an exponential chirp filtering sequence, and a hyperbolic chirp filtering sequence from a combination of a plurality of parameters based on the terminal capability information; and generating the combination of the plurality of parameters and the chirp filtering sequence as the control information.

The at least one processor may cause the base station to perform: generating a frequency shift value for frequency shift keying (FSK) modulation of the terminal based on the terminal capability information; generating a new parameter combination by resetting a value of each of the plurality of parameters based on the frequency shift value; and generating the one chirp filtering sequence based on the new parameter combination.

The control information may include a time-domain chirp filtering sequence generated based on a combination of a plurality of parameters, and the at least one processor may cause the base station to perform: transforming the time-domain chirp filtering sequence into a frequency-domain chirp filtering sequence; obtaining transmission modulation symbols based on the frequency-domain chirp filtering sequence; and converting the transmission modulation symbols into an RF signal and transmitting the RF signal as the sensing-integrated downlink channel and signal.

The at least one processor may cause the base station to perform: transforming the reflected sensing-integrated downlink channel and signal to obtain a frequency-domain signal; de-mapping an effective bandwidth of the frequency-domain signal to obtain received modulation symbols; equalizing the received modulation symbols to obtain equalized received modulation symbols; obtaining a beat signal from the equalized received modulation symbols; and determining the round-trip delay by obtaining at least one of an estimated beat frequency, an estimated distance, or an estimated resolution from the beat signal.

The at least one processor may cause the base station to perform: transforming the equalized received modulation symbols to obtain time-domain equalized received modulation symbols; obtaining a time-domain beat signal from the time-domain equalized received modulation symbols; and transforming the time-domain beat signal to obtain a frequency-domain beat signal.

The at least one processor may cause the base station to perform: obtaining a frequency-domain beat signal from the reflected sensing-integrated downlink channel and signal; phase-rotating the frequency-domain beat signal; transforming the phase-rotated frequency-domain beat signal to obtain a time-domain beat signal; obtaining a down-sampled beat signal from the time-domain beat signal based on a preset decimation factor; obtaining a padded beat signal from the down-sampled beat signal; and determining the round-trip delay from the padded beat signal based on the decimation factor.

The at least one processor may cause the base station to perform: combining down-sampled beat signals with different decimation points in a co-phasing manner; zero-padding the combined down-sampled beat signals to obtain a time-domain padded beat signal; and transforming the time-domain padded beat signal to obtain a frequency-domain padded beat signal.

According to the present disclosure, the base station can perform downlink communication and round-trip delay determination within the same time and frequency resources using the sensing-integrated downlink channel and signal transmitted to the terminal. Accordingly, the base station can enhance the performance of round-trip delay determination within a limited bandwidth and obtain a refined power delay profile (PDP) for multipath, enabling the acquisition of a high-resolution delay-domain channel. Additionally, by performing round-trip delay determination alongside downlink communication, the base station can prevent multi-user scheduling constraints, improve the accuracy of round-trip delay determination within a limited bandwidth, and reduce the terminal's battery consumption.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a sequence chart illustrating an exemplary embodiment of a method for transmitting a sensing-integrated downlink channel and signal between a base station and a terminal in a communication network.

FIG. 4 is a flowchart illustrating an exemplary embodiment of a method for a base station to determine a round-trip delay from a reflected sensing-integrated downlink channel and signal.

FIG. 5 is a flowchart illustrating an exemplary embodiment of a method for a base station to improve the performance of round-trip delay determination from a reflected sensing-integrated downlink channel and signal.

FIG. 6 is a flowchart illustrating an exemplary embodiment of a method for a terminal to decode a sensing-integrated downlink channel and signal.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

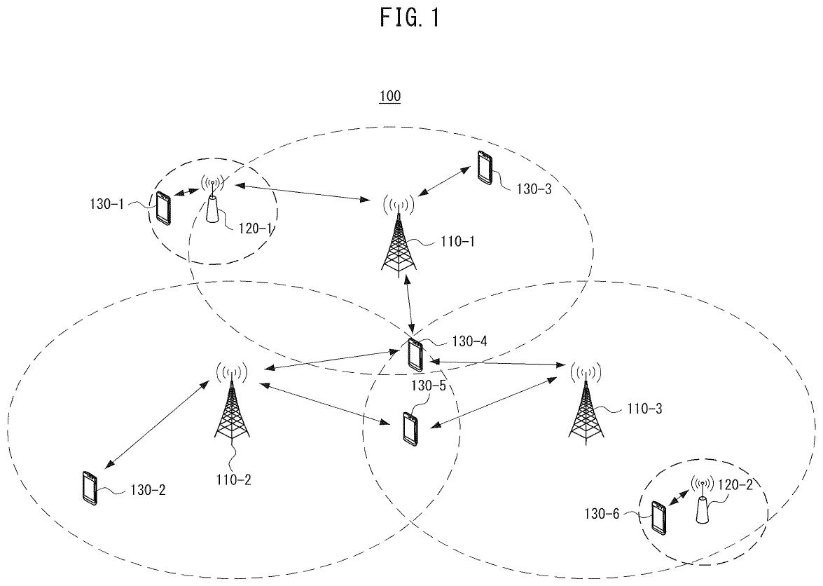

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

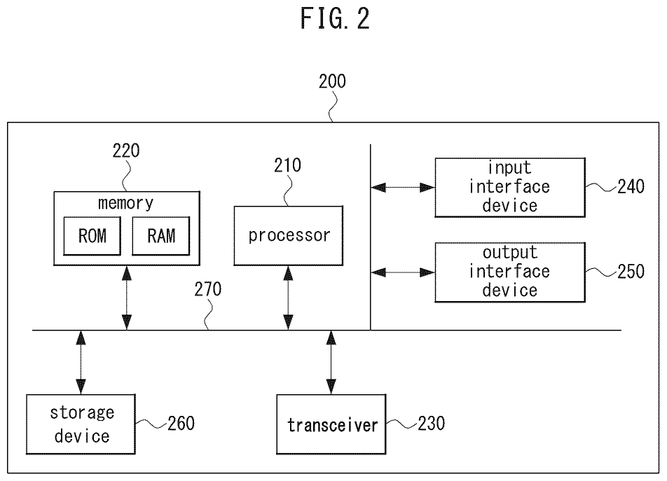

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

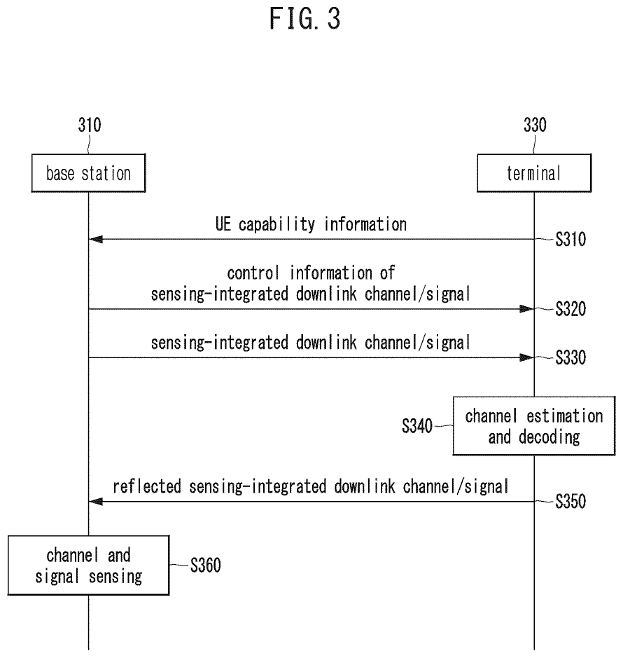

FIG. 3 is a sequence chart illustrating an exemplary embodiment of a method for transmitting a sensing-integrated downlink channel and signal between a base station and a terminal in a communication network.

A base station 310 shown in FIG. 3 may be one of the plurality of base stations 110-1, 110-2, 110-3, 120-1, and 120-2 constituting the communication network in FIG. 1. A terminal 330 shown in FIG. 3 may be one of the plurality of user terminals 130-1, 130-2, 130-3, 130-4, 130-5, and 130-6 constituting the communication network in FIG. 1.

In the present disclosure, the base station 310 may transmit a sensing-integrated downlink channel and signal to the terminal 330. The sensing-integrated downlink channel and signal may be a downlink channel and signal for estimating a round-trip delay of signal transmission and reception between the base station 310 and the terminal 330. The sensing-integrated downlink channel and the sensing-integrated downlink signal may be mapped to mutually orthogonal resources in time and frequency resources.

The sensing-integrated downlink channel may include at least one of data or message modulation symbols filtered with a compressed high-intensity radar pulse (chirp) sequence. The data or message modulation symbols may be symbols obtained by modulating a data or message sequence delivered to a physical layer through a higher layer.

The sensing-integrated downlink signal may include at least one of modulation symbols of a reference signal or a synchronization signal filtered with a chirp sequence. The reference signal may include at least one of a channel state information reference signal (CSI-RS), a demodulation reference signal (DMRS), or a phase tracking reference signal (PT-RS). The synchronization signal may include at least one of a primary synchronization signal (PSS) or a secondary synchronization signal (SSS). The reference signal modulation symbol may be a symbol obtained by modulating a reference signal sequence, and the synchronization signal modulation symbol may be a symbol obtained by modulating a synchronization signal sequence.

Referring to FIG. 3, the terminal 330 may report user equipment (UE) capability information to the base station 310 (S310). For example, the terminal 330 may include a radio frequency (RF) chip that performs frequency shift keying (FSK) modulation on a received channel and signal and reflects the received channel and signal. The terminal may perform FSK modulation on the received channel and signal with a single or multiple frequency shift values through the RF chip. Accordingly, the terminal may report UE capability information including at least one of whether FSK modulation through the RF chip is possible, a frequency band available for modulation, and an entire set or a subset of frequency shift values to the base station 310. The terminal 330 may report capability information required for transmitting and receiving the sensing-integrated downlink channel and signal to the base station 310.

The base station 310 may receive the UE capability information and, based on the received information, generate control information related to an integrated downlink channel and signal and transmit the control information to the terminal 330 (S320). The control information may include at least one of downlink channel-related control information and downlink signal-related control information.

The downlink channel-related control information may include at least one of an indicator indicating that the corresponding channel is a sensing-integrated downlink channel, a combination of a plurality of parameters, a chirp filtering sequence generated according to the combination of the plurality of parameters, whether the terminal performs FSK modulation based on the UE capability information, frequency shift value(s) or whether the terminal operates a retroreflective array, an extended cyclic prefix (CP) length configuration value, or parameters for channel decoding. The downlink channel-related control information may be indexed and managed using a look-up table (LUT).

The downlink signal-related control information may include at least one of an indicator indicating that the corresponding signal is a sensing-integrated downlink signal, whether the terminal performs FSK modulation based on the UE capability information, frequency shift value(s) or whether the terminal operates a retroreflective array, an extended CP length configuration value, or related parameters needed for the terminal 330 to estimate a channel or synchronization based on an allocated signal.

In the present disclosure, the sensing-integrated downlink channel and signal transmitted from the base station 310 to the terminal 330 may be a channel and signal filtered by a chirp sequence (i.e. chirp filtering sequence). The chirp filtering sequence may include at least one of a linear chirp filtering sequence, an exponential chirp filtering sequence, or a hyperbolic chirp filtering sequence.

Among the chirp filtering sequences, the linear chirp filtering sequence may be a sequence obtained by sampling a continuous-time linear chirp filtering signal into N time-domain samples, where the time-domain samples are equally spaced with respect to a time-domain length. The continuous-time linear chirp filtering signal may be defined as shown in Equation 1 below. The base station 310 may generate the linear chirp filtering sequence as shown in Equation 2 below.

$$\begin{matrix}ϕ ( t ) = \prod ( \frac{t}{T} ) \cdot exp ( j 2 π ( {c}_{0} + {c}_{1} t + {c}_{2} {t}^{2} ) ) , 0 \leq t < T \\ \prod ( \frac{t}{T} ) = \{ \begin{matrix}1 , & 0 \leq t < T \\ 0 , & otherwise\end{matrix}\end{matrix} \qquad [ Equation 1 ]$$

Here, Π may represent a rectangular pulse, c₀, c₁, and c₂ may be parameter values, and T may be the time-domain length.

$$ϕ [ n ] = exp ( j 2 π ( {c}_{0} + {c}_{1} ( \frac{T}{N} n ) + {{c}_{2} ( \frac{T}{N} n )}^{2} ) ) , n = 0 , L … , N - 1 \qquad [ Equation 2 ]$$

Here, c₀, c₁, and c₂ may be parameter values, T may be the time-domain length, and N may be the number of time-domain samples.

The base station 310 may generate various types of linear chirp filtering sequences depending on combinations of parameter values c₀, c₁, and c₂. For example, the base station 310 may generate a linear up-down chirp filtering sequence with an effective bandwidth for a given sampling frequency based on a combination of parameter values c₀, c₁, and c₂ as shown in Equation 3 below, for an arbeatrary phase.

$$( {c}_{0} , {c}_{1} , {c}_{2} ) = ( {ϕ}_{0} , 0 , \frac{N}{2 {T}^{2}} ) \qquad [ Equation 3 ]$$

Here, ϕ₀ may denote an arbeatrary phase, T may be the time-domain length, and N may be the number of time-domain samples.

As another example, the base station 310 may generate a linear down-up chirp filtering sequence with an effective bandwidth for a given sampling frequency based on a combination of parameter values c₀, c₁, and c₂ as shown in Equation 4 below, for an arbeatrary phase.

$$( {c}_{0} , {c}_{1} , {c}_{2} ) = ( {ϕ}_{0} , - \frac{N}{2 T} , \frac{N}{2 {T}^{2}} ) \qquad [ Equation 4 ]$$

Here, ϕ₀ may denote an arbeatrary phase, T may be the time-domain length, and N may be the number of time-domain samples.

As another example, the base station 310 may generate a linear chirp filtering sequence with an effective bandwidth centered around a direct current (DC) subcarrier based on a combination of parameter values c₀, c₁, and c₂ as shown in Equation 5 below, for an arbeatrary phase.

$$( {c}_{0} , {c}_{1} , {c}_{2} ) = ( {ϕ}_{0} , - \frac{B}{2} , \frac{B}{2 T} ) \qquad [ Equation 5 ]$$

Here, ϕ₀ may denote an arbeatrary phase, T may be the time-domain length, and B may be the effective bandwidth with respect to the sampling frequency.

The base station 310 may generate an exponential chirp filtering sequence for a continuous-time linear chirp filtering signal as shown in Equation 6 below. The exponential chirp filtering sequence may be generated in various forms depending on combinations of parameter values c₀, c₁, and c₂.

$${ϕ}_{e} [ n ] = exp ( j 2 π ( {c}_{0} + \frac{{c}_{2}^{\frac{n}{N}} - 1}{ln ( {c}_{2} )} ) ) , n = 0 , 1 , … , N - 1 \qquad [ Equation 6 ]$$

Here, c₀, c₁, and c₂ may be parameter values, T may be the time-domain length, N may be the number of time-domain samples, and ln may be a natural logarithm function.

The base station 310 may generate a hyperbolic chirp filtering sequence for a continuous-time linear chirp filtering signal as shown in Equation 7 below. The hyperbolic chirp filtering sequence may be generated in various forms depending on combinations of parameter values c₀, c₁, and c₂.

$${ϕ}_{h} [ n ] = exp ( j 2 π ( {c}_{0} - \frac{{c}_{1} {c}_{2} T}{{c}_{2} - {c}_{1}} ln ( 1 - \frac{{c}_{2} - {c}_{1}}{{c}_{2} N} n ) ) ) , n = 0 , 1 , … , N - 1 \qquad [ Equation 7 ]$$

Here, c₀, c₁, and c₂ may be parameter values, T may be the time-domain length, N may be the number of time-domain samples, and ln may be a natural logarithm function.

The base station 310 may generate various combinations of parameters c₀, c₁, and c₂ for the above-described chirp filtering sequence and transmit them to the terminal 330 as control information related to the sensing-integrated downlink channel and signal. The base station 310 may index each parameter c₀, c₁, or c₂ or their combination using a look-up table (LUT) and transmit the indexed value.

For example, the base station 310 may generate a predefined fixed parameter combination from parameter values c₀, c₁, and c₂. The base station 310 may set some of the parameter values c₀, c₁, and c₂ as fixed parameters and set the remaining parameters as parameters corresponding to a frequency region, thereby generating a parameter combination. The base station 310 may also generate a different parameter combination for a unit set composed of one or more orthogonal frequency division multiplexing (OFDM) symbols for a time-domain region where the sensing-integrated downlink channel is allocated.

The base station 310 may transmit, to the terminal 330, whether the terminal 330 performs FSK modulation or a frequency shift value as control information related to the sensing-integrated downlink channel and signal, based on the received UE capability information. In this case, the base station 310 may generate a new parameter combination by resetting at least one of the parameters c₀, c₁, and c₂ based on the frequency shift value, as shown in Equation 8. The base station 310 may generate the above-described chirp filtering sequence, such as a linear chirp filtering sequence, an exponential chirp filtering sequence, or a hyperbolic chirp filtering sequence, based on the new parameter combination.

$${c}_{1}^{′} = {c}_{1} - {f}_{0} \qquad [ Equation 8 ]$$

Here, c₁ may be the parameter value, and f₀ may be the frequency shift value.

The chirp filtering sequence generated by the base station 310 may be a time-domain sequence. The base station 310 may obtain a frequency-domain chirp filtering sequence by performing discrete Fourier transform (DFT) on the time-domain chirp filtering sequence of Equation 2, as shown in Equation 9 below.

$$Φ [ k ] = \frac{1}{\sqrt{N}} {\sum }_{n = 0}^{N - 1} ϕ [ n ] exp ( - j \frac{2 π kn}{N} ) , k = 0 , 1 , … , N - 1 \qquad [ Equation 9 ]$$

Here, N may be the number of time-domain samples, and ϕ[n] may be the time-domain chirp filtering sequence.

The base station 310 may obtain a frequency-domain chirp filtering sequence by performing DFT on the linear up-down chirp filtering sequence of Equation 3 according to the parameter combination, as shown in Equation 10 below.

$$Φ [ k ] = exp ( j 2 π ( {ϕ}_{0} - \frac{1}{8} + \frac{{k}^{2}}{2 N} ) ) , k = 0 , 1 , … , N - 1 \qquad [ Equation 10 ]$$

Here, ϕ₀ may be an arbeatrary phase, and N may be the number of time-domain samples.

The base station 310 may generate a combination of frequency-domain parameter values c₀, c₁, and c₂ for the frequency-domain chirp filtering sequence of Equation 10, as shown in Equation 11 below.

$${( {c}_{0} , {c}_{1} , {c}_{2} )}_{f} = ( {ϕ}_{0} - \frac{1}{8} , 0 , \frac{1}{2 N} ) \qquad [ Equation 11 ]$$

Here, ϕ₀ may be an arbeatrary phase, and N may be the number of time-domain samples.

The base station 310 may obtain a frequency-domain chirp filtering sequence by performing DFT on the linear down-up chirp filtering sequence of Equation 4 according to the parameter combination, as shown in Equation 12 below.

$$Φ [ k ] = exp ( j 2 π ( {ϕ}_{0} - \frac{N - 1}{8} + \frac{k}{2} + \frac{{k}^{2}}{2 N} ) ) , k = 0 , 1 , … , N - 1 \qquad [ Equation 12 ]$$

Here, ϕ₀ may be an arbeatrary phase, and N may be the number of time-domain samples.

The base station 310 may generate a combination of frequency-domain parameter values c₀, c₁, and c₂ for the frequency-domain chirp filtering sequence of Equation 12, as shown in Equation 13 below.

$${( {c}_{0} , {c}_{1} , {c}_{2} )}_{f} = ( {ϕ}_{0} - \frac{N - 1}{8} , \frac{1}{2} , \frac{1}{2 N} ) \qquad [ Equation 13 ]$$

Here, ϕ₀ may be an arbeatrary phase, and N may be the number of time-domain samples.

The base station 310 may generate a chirp-filtered transmission modulation symbol for the k-th subcarrier in the frequency domain by multiplying a modulation symbol of the sensing-integrated downlink channel and signal with the frequency-domain chirp filtering sequence, as shown in Equation 14 below. The modulation symbol of the sensing-integrated downlink channel and signal may be a data/message modulation symbol of the sensing-integrated downlink channel, a reference signal modulation symbol of the sensing-integrated downlink signal, or a synchronization signal modulation symbol of the sensing-integrated downlink signal.

$$S [ k ] = Φ [ k ] \cdot X [ k ] , k = 0 , 1 , … , N - 1 \qquad [ Equation 14 ]$$

Here, Φ[k]] may be the frequency-domain chirp filtering sequence, X[k] may be the modulation symbol of the sensing-integrated downlink channel and signal, and N may be the number of time-domain samples.

The base station 310 may map the transmission modulation symbols to all subcarriers allocated to the sensing-integrated downlink channel or signal. The base station 310 may obtain time-domain transmission modulation symbols by performing inverse discrete Fourier transform (IDFT) on the transmission modulation symbols, as shown in Equation 15 below.

$$s [ n ] = \frac{1}{\sqrt{N}} {\sum }_{k = 0}^{N - 1} S [ k ] exp ( j \frac{2 π kn}{N} ) , n = 0 , 1 , … , N - 1 \qquad [ Equation 15 ]$$

Here, S[k] may be the transmission modulation symbols, and N may be the number of time-domain samples.

The time-domain transmission modulation symbols may have characteristics as described in Equation 16 below.

$$s [ n ] = ( ϕ ⊙ * x ) [ n ] , n = 0 , 1 , … , N - 1 \qquad [ Equation 16 ]$$

Here, \textcircled{*} may be a discrete cyclic convolution operator.

The base station 310 may map the transmission modulation symbols to only a subset of the subcarriers allocated to the sensing-integrated downlink channel or signal. For example, the base station 310 may map the transmission modulation symbols to the effective bandwidth of the sampling frequency of the linear chirp filtering sequence within the bandwidth of the sensing-integrated downlink channel or signal. In this case, the base station 310 may null subcarriers where the transmission modulation symbols are not mapped and obtain time-domain transmission modulation symbols by performing IDFT, as shown in Equation 17 below.

$$s [ n ] = \frac{1}{\sqrt{N}} {\sum }_{k = 0}^{{N}_{s} - 1} S [ k ] exp ( j \frac{2 π kn}{{N}_{s}} ) , n = 0 , 1 , … , {N}_{s} - 1 \qquad [ Equation 17 ]$$

Here, Š[k] may be the transmission modulation symbols, and N may be the number of time-domain samples.

If Nₛ is equal to N in Equation 17, the sampling frequency may be the same as the effective bandwidth (or effective frequency band). As a result, the time-domain transmission modulation symbols according to Equation 17 may be the same as those according to Equation 15.

The base station 310 may convert the time-domain transmission modulation symbols into an RF signal through digital-to-analog conversion (DAC), frequency conversion, power amplification, analog filtering, or analog beamforming. The base station 310 may transmit the converted RF signal to the terminal 330 as the sensing-integrated downlink channel and signal (S330).

The terminal 330 may receive the sensing-integrated downlink channel and signal from the base station 310. The terminal 330 may estimate the received sensing-integrated downlink channel and decode the sensing-integrated downlink channel and signal based on the estimated channel (S340).

Meanwhile, the terminal 330 may perform FSK modulation on the received sensing-integrated downlink channel and signal and reflect the received sensing-integrated downlink channel and signal. The base station 310 may receive the reflected sensing-integrated downlink channel and signal from the terminal 330 (S350).

The base station 310 may receive the reflected sensing-integrated downlink channel and signal from the terminal 330 and determine a round-trip delay of the previously transmitted sensing-integrated downlink channel and signal based on the reflected sensing-integrated downlink channel and signal (S360).

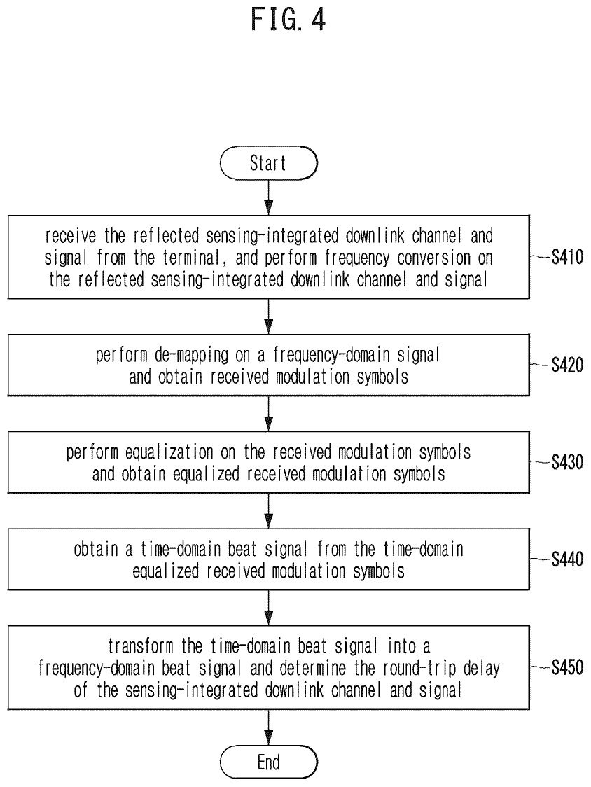

FIG. 4 is a flowchart illustrating an exemplary embodiment of a method for a base station to determine a round-trip delay from a reflected sensing-integrated downlink channel and signal.

Referring to FIG. 4, the base station 310 may receive the reflected sensing-integrated downlink channel and signal from the terminal 330. The base station 310 may perform frequency conversion on the reflected sensing-integrated downlink channel and signal (S410).

The reflected sensing-integrated downlink channel and signal may be a round-trip reception signal and may be defined as shown in Equation 18 below.

$$r [ n ] = \sqrt{α {P}_{c}} ( h ⊙ * \tilde{s} ) [ n ] + \sqrt{β} ψ \sqrt{{P}_{t}} \tilde{s} [ n ] + {w}_{r} [ n ] , n = 0 , 1 , … , N - 1 \qquad [ Equation 18 ]$$

Here, α may be a path attenuation of a round-trip channel, β may be a path attenuation of a self-interference channel, Pₜ may be a transmission power, h[n] may be the n-th round-trip channel tap, ψ may be a self-interference channel coefficient, \tilde{s}[n] may be the transmission modulation symbol, N may be the number of time-domain samples, and wᵣ[n] may be additive white Gaussian noise (AWGN).

The round-trip channel and the self-interference channel may be baseband effective channels that include the effects of transmission and reception analog or digital beamforming and analog or digital filtering of the base station 310, and a reflection array coefficient of the terminal 330. The base station 310 may cancel the self-interference component through transmission and reception analog or digital beamforming, analog or digital filtering, and similar processes.

The reflected sensing-integrated downlink channel and signal may be a time-domain round-trip reception signal. The base station 310 may perform self-interference suppression filtering on the reflected sensing-integrated downlink channel and signal and perform frequency conversion, such as discrete Fourier transform (DFT), to obtain a frequency-domain signal.

The base station 310 may perform de-mapping on the frequency-domain signal and obtain received modulation symbols (S420).

The base station 310 may perform de-mapping with respect to the effective bandwidth of the frequency-domain signal. The base station 310 may obtain a de-mapped signal, that is, received modulation symbols, as shown in Equation 19 below, through de-mapping.

$$\tilde{R} [ k ] = \sqrt{α {P}_{t}} H [ k ] S [ k ] + \tilde{W} [ k ] , k = 0 , 1 , … , N - 1 \qquad [ Equation 19 ]$$

Here, α may be a path attenuation of the round-trip channel, Pₜ may be the transmission power, S[k] may the transmission modulation symbols, H[k] may be the frequency-domain round-trip channel coefficient of the k-th subcarrier, and \tilde{W}[k] may be noise corresponding to the k-th subcarrier.

The base station 310 may perform equalization on the received modulation symbols and obtain equalized received modulation symbols (S430).

The base station 310 may perform zero-forcing (ZF) equalization, which divides the received modulation symbols by the modulation symbols of the sensing-integrated downlink channel and signal. The base station 310 may obtain equalized received modulation symbols as shown in Equation 20 below based on the equalization on the received modulation symbols.

$$\hat{R} [ k ] = \frac{\tilde{R} [ k ]}{X [ k ]} = \sqrt{α {P}_{t}} H [ k ] Φ [ k ] + Z [ k ] , k = 0 , 1 , … , N - 1 \qquad [ Equation 20 ]$$

Here, \tilde{R}[k] may be the received modulation symbols, X[k] may be the modulation symbols of the sensing-integrated downlink channel and signal, α may be the path attenuation of the round-trip channel, Pₜ may be the transmission power, H[k] may be the frequency-domain round-trip channel coefficient of the k-th subcarrier, and Z[k] may be noise corresponding to the k-th subcarrier.

The base station 310 may perform IDFT on the equalized received modulation symbols and obtain time-domain equalized received modulation symbols as shown in Equation 21 below.

$$r [ n ] = \sqrt{α {P}_{t}} ( h ⊙ ϕ ) [ n ] + z [ n ] , n = 0 , 1 , … , N - 1 \qquad [ Equation 21 ]$$

Here, α may be the path attenuation of the round-trip channel, Pₜ may be the transmission power, h[n] may be the n-th round-trip channel tap, ϕ[n] may be the time-domain chirp filtering sequence, and N may be the number of time-domain samples.

The base station 310 may obtain a time-domain beat signal from the time-domain equalized received modulation symbols as shown in Equation 22 below (S440).

$$\begin{matrix}b [ n ] = {\hat{r}}^{*} [ n ] \cdot ϕ [ n ] \\ = \sqrt{α {P}_{t}} {\sum }_{l = {L}_{0}}^{{L}_{0} + L - 1} {h}^{*} [ l ] {ϕ}^{*} [ ( n - l ) mod N ] ϕ [ n ] + {z}^{*} [ n ] ϕ [ n ] , n = 0 , 1 , … , N - 1.\end{matrix} \qquad [ Equation 22 ]$$

Here, * may be a complex conjugate operator, α may be the path attenuation of the round-trip channel, Pₜ may be the transmission power, L₀ may be the minimum index of nonzero channel taps, L may be the number of nonzero channel taps, h[l] may be the l-th round-trip channel tap, Φ[n] may be the time-domain chirp filtering sequence, z [n] may be noise, and N may be the number of time-domain samples.

The base station 310 may substitute the time-domain chirp filtering sequence of Equation 22 with the linear down-up chirp filtering sequence of Equation 4 according to the parameter combination. The base station 310 may obtain the time-domain beat signal as shown in Equation 23.

$$b [ n ] = \sqrt{α {P}_{t}} {\sum }_{l = {L}_{0}}^{{L}_{0} + L - 1} {h}^{*} [ l ] exp ( - j π ( l + \frac{{l}^{2}}{N} ) + j \frac{2 π ln}{N} ) + {z}^{⌣} [ n ] , n = 0 , 1 , … , N - 1 \qquad [ Equation 23 ]$$

Here, * may be a complex conjugate operator, α may be the path attenuation of the round-trip channel, Pₜ may be the transmission power, L₀ may be the minimum index of nonzero channel taps, L may be the number of nonzero channel taps, h[l] may be the l-th round-trip channel tap, ϕ[n] may be the time-domain chirp filtering sequence, ž [n] may be noise, and N may be the number of time-domain samples.

The base station 310 may transform the time-domain beat signal into a frequency-domain beat signal and determine the round-trip delay of the sensing-integrated downlink channel and signal based on the converted beat signal (S450).

The base station 310 may obtain the frequency-domain beat signal by performing DFT on the time-domain beat signal, as shown in Equation 24 below.

$$B [ k ] = \{ \begin{matrix}\sqrt{α {P}_{t} N} {h}^{*} [ k ] exp ( - j π ( k + \frac{{k}^{2}}{N} ) ) + {Z}^{⌣} [ k ] , k = {L}_{0} , {L}_{0} + 1 , … , {L}_{0} + L - 1 \\ {Z}^{⌣} [ k ] , otherwise\end{matrix} \qquad [ Equation 24 ]$$

Here, * may be a complex conjugate operator, α may be the path attenuation of the round-trip channel, Pₜ may be the transmission power, h[k] may be the k-th round-trip channel tap, Ž [k] may be noise, N may be the number of time-domain samples, L₀ may be the minimum index of nonzero channel taps, and L may be the number of nonzero channel taps.

A single line-of-sight (LoS) path may be configured between the base station 310 and the terminal 330. Based on the single LoS path, the k-th round-trip channel tap of the baseband channel may be modeled as shown in Equation 25 below.

$$B [ k ] = \{ \begin{matrix}sinc ( T ( \frac{k}{T} - {f}_{r} ) ) , k = {L}_{0} , {L}_{0} + 1 , … , {L}_{0} + L - 1 \\ 0 , otherwise\end{matrix} \qquad [ Equation 25 ]$$

Here, sinc may denote a sinc function, and fᵣ may be a beat frequency.

Additionally, the beat frequency fᵣ may be given as fᵣ=fₛτ/T, where T=2R/c, R may be the LoS path distance between the base station and the terminal, and c may be the speed of light.

The base station 310 may obtain an estimated beat frequency from the frequency-domain beat signal as shown in Equation 26, based on Equation 25.

$$\hat{{f}_{r}} = arg {max}_{k} \vert B [ k ] \vert / T \qquad [ Equation 26 ]$$

Here, B[k] may be the frequency-domain beat signal, and T may be the time-domain length.

The base station 310 may obtain an estimated distance based on the estimated beat frequency as shown in Equation 27 below.

$$\hat{R} = \frac{c \hat{{f}_{r}} T}{2 {f}_{s}} \qquad [ Equation 27 ]$$

Here, c may be the speed of light, and fᵣ may be the beat frequency.

The base station 310 may obtain an estimated resolution based on the obtained estimated distance as shown in Equation 28 below.

$$Δ \hat{R} = \frac{c Δ fT}{2 {f}_{s}} = \frac{c}{2 {f}_{s}} \qquad [ Equation 28 ]$$

Here, c may be the speed of light, and Δf may be a subcarrier spacing.

As described above, the reflected sensing-integrated downlink channel and signal received by the base station 310 may be the round-trip reception signal for the downlink transmission of the base station 310. The base station 310 may determine the round-trip delay for the downlink channel and signal transmission of the base station 310 based on at least one of the estimated beat frequency, distance, or resolution obtained from the reflected sensing-integrated downlink channel and signal.

For example, the base station 310 may obtain the estimated round-trip delay as shown in Equation 29 based on the estimated beat frequency obtained according to Equation 26.

$$\hat{τ} = \frac{\hat{{f}_{r}}}{2 {c}_{2}} \qquad [ Equation 29 ]$$

Here, \hat{f}ᵣ may be the estimated beat frequency, and c may be the speed of light.

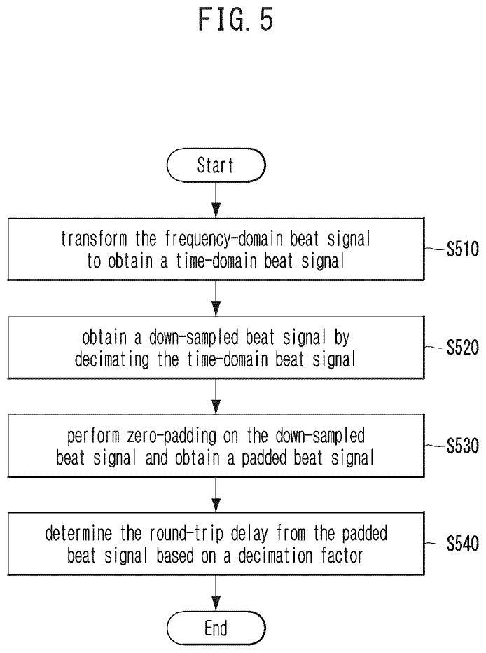

FIG. 5 is a flowchart illustrating an exemplary embodiment of a method for a base station to improve the performance of round-trip delay determination from a reflected sensing-integrated downlink channel and signal.

Referring to FIG. 5, the base station 310 may obtain the reflected sensing-integrated downlink channel and signal from the terminal 330 and obtain a frequency-domain beat signal from the reflected sensing-integrated downlink channel and signal. The base station 310 may transform the frequency-domain beat signal to obtain a time-domain beat signal (S510).

The base station 310 may perform self-interference suppression filtering on the reflected sensing-integrated downlink channel and signal and perform DFT to obtain a frequency-domain signal. The base station 310 may obtain received modulation symbols through de-mapping with respect to the effective bandwidth of the frequency-domain signal and obtain equalized received modulation symbols by performing equalization on the received modulation symbols. The base station 310 may perform IDFT on the equalized received modulation symbols to obtain time-domain equalized received modulation symbols and obtain the time-domain beat signal from the time-domain equalized received modulation symbols. The base station 310 may perform DFT on the time-domain beat signal to obtain a frequency-domain beat signal.

The base station 310 may phase-rotate the frequency-domain beat signal and obtain a phase-rotated signal for subcarriers as shown in Equation 30. The base station 310 may perform IDFT on the phase-rotated frequency-domain beat signal to obtain a time-domain beat signal.

$$\overline{B} [ k ] = B [ k ] exp ( j π \frac{{k}^{2} + k}{N} ) , k = 0 , 1 , … , N - 1 \qquad [ Equation 30 ]$$

Here, B[k] may be the frequency-domain beat signal.

The base station 310 may decimate the time-domain beat signal based on a predefined factor, such as a decimation factor. The base station 310 may obtain a down-sampled beat signal for multiple different decimation points as shown in Equation 31 below (S520).

$${\tilde{b}}^{( d )} [ n ] = \overline{b} [ Dn + d ] , n = 0 , 1 , … , \frac{N}{D} - 1 \qquad [ Equation 31 ]$$

Here, b̅[n] may be the time-domain beat signal, D may be the decimation factor, and d may be the decimation point.

The base station 310 may set the decimation factor by considering at least one of the distance to the terminal 330, inter-site distance (ISD), CP length, transmission power, or timing advance (TA).

The base station 310 may combine the down-sampled beat signal with different decimation points in a co-phasing manner, as shown in Equation 32, based on the previously obtained estimated beat frequency.

$$\tilde{b} [ n ] = \frac{1}{\sqrt{D}} {\sum }_{d = 0}^{D - 1} {\tilde{b}}^{( d )} [ n ] exp ( - j 2 π \hat{{f}_{r}} {T}_{s} d ) , n = 0 , 1 , … , \frac{N}{D} - 1 \qquad [ Equation 32 ]$$

Here, D may be the decimation factor, d may be the decimation point, and \hat{f}ᵣ may be the estimated beat frequency.

The base station 310 may perform zero-padding on the down-sampled beat signal and obtain a padded beat signal as shown in Equation 33 below (S530).

$$\hat{b} [ n ] = \{ \begin{matrix}\tilde{b} [ n ] , n = 0 , 1 , … , \frac{N}{D} - 1 \\ 0 , otherwise\end{matrix} \qquad [ Equation 33 ]$$

Here, \tilde{b}[n] may be the down-sampled beat signal, and D may be the decimation factor.

The base station 310 may perform DFT on the padded beat signal to obtain a frequency-domain padded beat signal as shown in Equation 34 below.

$$[ Equation 34 ]$$

$$\hat{B} [ k ] = \{ \begin{matrix}\begin{matrix}\sqrt{α {P}_{t} DN} sin c ( T ( \frac{k}{MDT} - {f}_{r} ) ) exp ( - j π \frac{N - 1}{N} k ) + \hat{Z} [ k ] , \\ k = {MDL}_{0} , … , MD ( {L}_{0} + L - 1 )\end{matrix} \\ \hat{Z} [ k ] , otherwise\end{matrix}$$

Here, α may be the path attenuation of the round-trip channel, Pₜ may be the transmission power, D may be the decimation factor, N may be the number of time-domain samples, sinc may denote a sinc function, M may be a ratio of the DFT size to the number N of time-domain samples, T may be the time-domain length, fᵣ may be the beat frequency, and \hat{Z}[k] may be noise.

The base station 310 may obtain the estimated beat frequency from the frequency-domain padded beat signal based on the decimation factor as shown in Equation 35 below. The base station 310 may obtain the estimated round-trip delay based on the estimated beat frequency as shown in Equation 36 below. The base station 310 may obtain the estimated distance based on the estimated round-trip delay as shown in Equation 37 below. The base station 310 may determine the round-trip delay for the integrated downlink channel and signal based on the estimated beat frequency or estimated distance (S540).

$$\hat{{f}_{r}} = arg {max}_{k} \vert \hat{B} [ k ] \vert / MLT \qquad [ Equation 35 ]$$

Here, \hat{B}[k] may be the padded beat signal, M may be a ratio of the DFT size to the number N of time-domain samples, L may be the number of nonzero channel taps, and T may be the time-domain length.

$$\hat{τ} = \frac{\hat{{f}_{r}}}{2 {c}_{2}} \qquad [ Equation 36 ]$$

Here, \hat{f}ᵣ may be the estimated beat frequency, and c may be the speed of light.

$$\hat{R} = \frac{c \hat{τ}}{2} \qquad [ Equation 37 ]$$

Here, \hat{τ} may be the estimated round-trip delay, and c may be the speed of light.

The base station 310 may combine zero-padding or oversampling techniques to improve the estimation resolution of the beat frequency or enhance the estimated signal-to-noise ratio (SNR). The base station 310 may improve the accuracy of beat frequency estimation, round-trip delay estimation, and distance estimation.

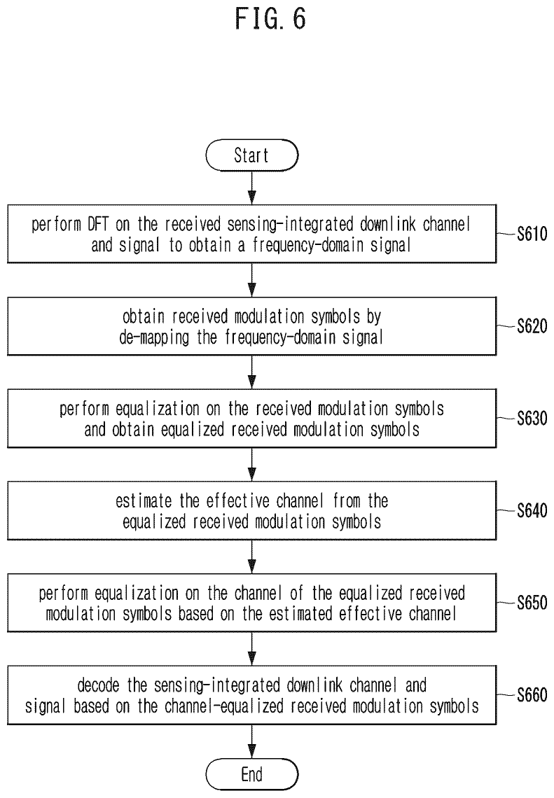

FIG. 6 is a flowchart illustrating an exemplary embodiment of a method for a terminal to decode a sensing-integrated downlink channel and signal.

Referring to FIG. 6, the terminal 330 may receive an RF signal (e.g. time-domain sensing-integrated downlink channel and signal) from the base station 310. The terminal 330 may perform DFT on the time-domain sensing-integrated downlink channel and signal to obtain a frequency-domain signal (S610).

The sensing-integrated downlink channel and signal received by the terminal 330 may be defined as shown in Equation 38 below.

$$y [ n ] = \sqrt{γ {P}_{t}} ( g ⊗ \tilde{s} ) [ n ] + {w}_{c} [ n ] , n = 0 , 1 , … , {N}_{s} - 1 \qquad [ Equation 38 ]$$

Here, γ may be an attenuation of an effective communication channel, Pₜ may be the transmission power, g[n] may be the n-th communication channel tap, \tilde{s}[n] may be the transmission modulation symbol, w_{c}[n] may be AWGN, and Nₛ may be the time-domain length.

The effective communication channel may be a baseband effective channel based on transmission analog/digital beamforming and analog/digital filtering of the base station 310, or reception analog/digital beamforming of the terminal 330. For example, the base station 310 may suppress the self-interference component through transmission analog/digital beamforming or analog/digital filtering and may perform beamforming on the sensing-integrated downlink channel and signal toward the terminal 330. The terminal 330 may perform beamforming toward the base station 310 through reception analog/digital beamforming.

The terminal 330 may obtain received modulation symbols through de-mapping with respect to the effective bandwidth of the frequency-domain signal, as shown in Equation 39 below (S620).

$$y [ k ] = \sqrt{γ} G [ k ] \sqrt{{P}_{t}} X [ k ] Φ [ k ] + {W}_{c} [ k ] , k = 0 , 1 , … , N - 1 \qquad [ Equation 39 ]$$

Here, γ may be the attenuation of the effective communication channel, Pₜ may be the transmission power, G[k] may be the communication channel tap for the subcarrier index k, X[k] may be the modulation symbol of the sensing-integrated downlink channel and signal, Φ[k] may be the frequency-domain chirp filtering sequence, W_{c}[k] may be noise, N may be the time-domain length, and k may be the subcarrier index.

The terminal 330 may perform equalization on the received modulation symbols and obtain equalized received modulation symbols as shown in Equation 40 below (S630). The terminal 330 may perform zero-forcing (ZF) equalization.

$$\begin{matrix}\hat{Y} [ k ] = \frac{Y [ k ]}{Φ [ k ]} \\ = \sqrt{γ} G [ k ] \sqrt{{P}_{t}} X [ k ] Φ [ k ] + {\hat{W}}_{c} [ k ] , k = 0 , 1 , … , N - 1\end{matrix} \qquad [ Equation 40 ]$$

Here, Y[k] may be the received modulation symbols, γ may be the attenuation of the effective communication channel, Pₜ may be the transmission power, G[k] may be the communication channel tap for the subcarrier index k, X[k] may be the modulation symbols of the sensing-integrated downlink channel and signal, Φ[k] may be the frequency-domain chirp filtering sequence, Ŵ_{c}[k] may be the effective noise, N may be the time-domain length, and k may be the subcarrier index.

The terminal 330 may estimate the effective channel from the equalized received modulation symbols (S640). The terminal 330 may perform equalization on the channel of the equalized received modulation symbols based on the estimated effective channel (S650). The terminal 330 may decode the data and message modulation symbols of the sensing-integrated downlink channel and signal from the channel-equalized received modulation symbols (S660).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
generating control information for a sensing-integrated downlink channel and signal;
generating the sensing-integrated downlink channel and signal based on the control information and transmitting the sensing-integrated downlink channel and signal to a terminal;
receiving a reflected sensing-integrated downlink channel and signal for the sensing-integrated downlink channel and signal from the terminal; and
determining a round-trip delay for the sensing-integrated downlink channel and signal based on the reflected sensing-integrated downlink channel and signal.

2. The method according to claim 1, wherein the method of the base station further comprises:
receiving terminal capability information from the terminal,
wherein the generating of the control information comprises:
generating a chirp filtering sequence from a combination of a plurality of parameters based on the terminal capability information; and
generating the combination of the plurality of parameters and the chirp filtering sequence as the control information.

3. The method according to claim 2, wherein the generating of the chirp filtering sequence comprises: generating one chirp filtering sequence of a linear up-down chirp filtering sequence, a linear down-up chirp filtering sequence, an exponential chirp filtering sequence, and a hyperbolic chirp filtering sequence based on the combination of the plurality of parameters.

4. The method according to claim 2, wherein the generating of the chirp filtering sequence comprises:
generating a frequency shift value for frequency shift keying (FSK) modulation of the terminal based on the terminal capability information;
generating a new parameter combination by resetting a value of each of the plurality of parameters based on the frequency shift value; and
generating the chirp filtering sequence based on the new parameter combination.

5. The method according to claim 1, wherein the control information includes a time-domain chirp filtering sequence generated based on a combination of a plurality of parameters, and the generating of the sensing-integrated downlink channel and signal and transmitting of the sensing-integrated downlink channel and signal to the terminal comprises:
transforming the time-domain chirp filtering sequence into a frequency-domain chirp filtering sequence;
obtaining transmission modulation symbols based on the frequency-domain chirp filtering sequence; and
converting the transmission modulation symbols into an RF signal and transmitting the RF signal as the sensing-integrated downlink channel and signal.

6. The method according to claim 1, wherein the determining of the round-trip delay comprises:
transforming the reflected sensing-integrated downlink channel and signal to obtain a frequency-domain signal;
de-mapping an effective bandwidth of the frequency-domain signal to obtain received modulation symbols;
equalizing the received modulation symbols to obtain equalized received modulation symbols;
obtaining a beat signal from the equalized received modulation symbols; and
determining the round-trip delay by obtaining at least one of an estimated beat frequency, an estimated distance, or an estimated resolution from the beat signal.

7. The method according to claim 6, wherein the obtaining of the beat signal comprises:
transforming the equalized received modulation symbols to obtain time-domain equalized received modulation symbols;
obtaining a time-domain beat signal from the time-domain equalized received modulation symbols; and
transforming the time-domain beat signal to obtain a frequency-domain beat signal.

8. The method according to claim 1, wherein the determining of the round-trip delay comprises:
obtaining a frequency-domain beat signal from the reflected sensing-integrated downlink channel and signal;
obtaining a time-domain beat signal by transforming the frequency-domain beat signal;
obtaining a down-sampled beat signal from the time-domain beat signal based on a preset decimation factor;
obtaining a padded beat signal from the down-sampled beat signal; and
determining the round-trip delay from the padded beat signal based on the decimation factor.

9. The method according to claim 8, wherein the obtaining of the time-domain beat signal comprises: phase-rotating the frequency-domain beat signal and transforming the phase-rotated frequency-domain beat signal to obtain the time-domain beat signal.

10. The method according to claim 8, wherein the obtaining of the padded beat signal comprises:
combining down-sampled beat signals with different decimation points in a co-phasing manner;
zero-padding the combined down-sampled beat signals to obtain a time-domain padded beat signal; and
transforming the time-domain padded beat signal to obtain a frequency-domain padded beat signal.

11. A method of a terminal, comprising:
receiving a sensing-integrated downlink channel and signal from a base station;
reflecting the sensing-integrated downlink channel and signal to the base station;
estimating an effective channel from the sensing-integrated downlink channel and signal; and
decoding the sensing-integrated downlink channel and signal based on the estimated effective channel.

12. The method according to claim 11, wherein the estimating of the effective channel comprises:
obtaining a frequency-domain signal by transforming the sensing-integrated downlink channel and signal;
de-mapping the frequency-domain signal to obtain received modulation symbols;
equalizing the received modulation symbols to obtain equalized received modulation symbols; and
estimating the effective channel from the equalized received modulation symbols.

13. A base station comprising at least one processor, wherein the at least one processor causes the base station to perform:
generating control information for a sensing-integrated downlink channel and signal;
generating the sensing-integrated downlink channel and signal based on the control information and transmitting the sensing-integrated downlink channel and signal to a terminal;
receiving a reflected sensing-integrated downlink channel and signal for the sensing-integrated downlink channel and signal from the terminal; and
determining a round-trip delay for the sensing-integrated downlink channel and signal based on the reflected sensing-integrated downlink channel and signal.

14. The base station according to claim 13, wherein the at least one processor causes the base station to perform:
receiving terminal capability information from the terminal,
generating one chirp filtering sequence of a linear up-down chirp filtering sequence, a linear down-up chirp filtering sequence, an exponential chirp filtering sequence, and a hyperbolic chirp filtering sequence from a combination of a plurality of parameters based on the terminal capability information, and
generating the combination of the plurality of parameters and the chirp filtering sequence as the control information.

15. The base station according to claim 14, wherein the at least one processor causes the base station to perform:
generating a frequency shift value for frequency shift keying (FSK) modulation of the terminal based on the terminal capability information;
generating a new parameter combination by resetting a value of each of the plurality of parameters based on the frequency shift value; and
generating the one chirp filtering sequence based on the new parameter combination.

16. The base station according to claim 13, wherein the control information includes a time-domain chirp filtering sequence generated based on a combination of a plurality of parameters, and the at least one processor causes the base station to perform:
transforming the time-domain chirp filtering sequence into a frequency-domain chirp filtering sequence;
obtaining transmission modulation symbols based on the frequency-domain chirp filtering sequence; and
converting the transmission modulation symbols into an RF signal and transmitting the RF signal as the sensing-integrated downlink channel and signal.

17. The base station according to claim 13, wherein the at least one processor causes the base station to perform:
transforming the reflected sensing-integrated downlink channel and signal to obtain a frequency-domain signal;
de-mapping an effective bandwidth of the frequency-domain signal to obtain received modulation symbols;
equalizing the received modulation symbols to obtain equalized received modulation symbols;
obtaining a beat signal from the equalized received modulation symbols; and
determining the round-trip delay by obtaining at least one of an estimated beat frequency, an estimated distance, or an estimated resolution from the beat signal.

18. The base station according to claim 17, wherein the at least one processor causes the base station to perform:
transforming the equalized received modulation symbols to obtain time-domain equalized received modulation symbols;
obtaining a time-domain beat signal from the time-domain equalized received modulation symbols; and
transforming the time-domain beat signal to obtain a frequency-domain beat signal.

19. The base station according to claim 13, wherein the at least one processor causes the base station to perform:
obtaining a frequency-domain beat signal from the reflected sensing-integrated downlink channel and signal;
phase-rotating the frequency-domain beat signal;
transforming the phase-rotated frequency-domain beat signal to obtain a time-domain beat signal;
obtaining a down-sampled beat signal from the time-domain beat signal based on a preset decimation factor;
obtaining a padded beat signal from the down-sampled beat signal; and
determining the round-trip delay from the padded beat signal based on the decimation factor.

20. The base station according to claim 19, wherein the at least one processor causes the base station to perform:
combining down-sampled beat signals with different decimation points in a co-phasing manner;
zero-padding the combined down-sampled beat signals to obtain a time-domain padded beat signal; and
transforming the time-domain padded beat signal to obtain a frequency-domain padded beat signal.
